(19) United States
(12) Patent Application Publication
(10) Pub. No.: US 2016/0290521 A1
(43) Pub. Date: Oct. 6, 2016

(54) NON-RETURN VALVE/FILTER UNIT

(71) Applicant: GEA AWP GmbH, Prenzlau (DE)

(72) Inventor: Thomas Strotkoetter, Prenzlau (DE)

(21) Appl. No.: 14/901,587

(22) PCT Filed: Jun. 27, 2014
(86) PCT No.: PCT/EP2014/001777

§ 371 Date: Dec. 28, 2015

(30) Foreign Application Priority Data
Jun. 28, 2013 (DE) 10 2013 010 780.6

(51) Int. Cl. F16K 27/02; F16K 15/02; F25B 43/00; B01D 35/153; F25B 31/00

(52) U.S. Cl. CPC F16K 27/0209; B01D 35/153; F25B 31/00; F25B 43/003; F16K 15/023

(57) ABSTRACT

A non-return valve/filter unit (10) for a compressor, more particularly for a compressor for compressing refrigerant, wherein the unit (10) has a housing (12), a first inlet (14) and an outlet (16) and a non-return valve (15), wherein the housing (12) for the unit (10) is a single T-shaped element, and the unit (10) has a second inlet (46) via which a pressure medium can be introduced under pressure, and a compressor that has a corresponding suction valve.

The invention relates to a non-return valve/filter assembly for a compressor, in particular for a compressor for compressing a refrigerant, according to the preamble of patent claim 1, and to a compressor according to the preamble of patent claim 9.

Compressors, in particular compressors for a refrigerant, in modern times are used in the most varied sectors of daily life. Compressors of this type are widely used in particular in the field of air conditioning, for example for motor vehicles or else for residential or commercial buildings, as well as in the field of refrigeration, for example for shipping and storing perishable goods.

In general, a medium to be compressed, which typically is available in the form of gas and which is supplied to compressors by way of a compressor inlet, is compressed in the compressor and is then made available to an application by way of a compressor outlet. An intake valve which comprises a non-return valve, so as to prevent undesirable flows of the medium to be compressed, is often disposed in the region of the compressor inlet. Furthermore, a filter which separates foreign bodies or foreign matter, respectively, from the refrigerant flow is often disposed ahead of the compressor inlet.

The intake valves and intake valve or non-return valve/filter assemblies mentioned above are constructed from many individual parts, leading to complex and cost-intensive production.

It is hence an object of the present invention to state a non-return valve/filter assembly which is manufacturable in a simple and thus also cost-effective manner. It is furthermore an object of the present invention to state a compressor which employs a corresponding non-return valve/filter assembly.

This object is achieved according to the invention by a non-return valve/filter assembly according to patent claim 1. The achievement of the object according to the invention is provided by a non-return valve/filter assembly for a compressor, in particular for a compressor for compressing a refrigerant, wherein the assembly has a housing, an inlet, and an outlet, as well as a non-return valve. The housing of the assembly (10) is configured in an integral and T-shaped manner, and the assembly has an inlet by way of which a pressurized impinging medium is suppliable. The T-shape and the integral construction type of the housing ensure a compact shape of the assembly at manufacturing costs which at the same time are low. The non-return valve does not have a spring mechanism but is pushed or urged, respectively, by a pressurized medium (impinging medium) in the direction of a closing position of the valve (that is to say is impinged by way of force or pressure). On account thereof, yet further considerable downsizing of the assembly is enabled. The omission of the spring furthermore gives rise to a very low natural frequency. Valve rattling may be avoided even in the case of only minor volumetric currents (for example partial volumetric currents) passing through the assembly.

The aspect of the set object which concerns a compressor is achieved by a compressor, in particular a compressor for compressing a refrigerant, according to patent claim 9. It should be noted at this point that the invention is not limited to a compressor for compressing a refrigerant. The invention may also be implemented in other conceivable compressors, such as in compressors for compressing air or other media, for example.

Further features of the invention are stated in the dependent claims.

The invention will be described hereunder in an exemplary manner with reference to the appended drawing and by means of a preferred embodiment. In the drawing:

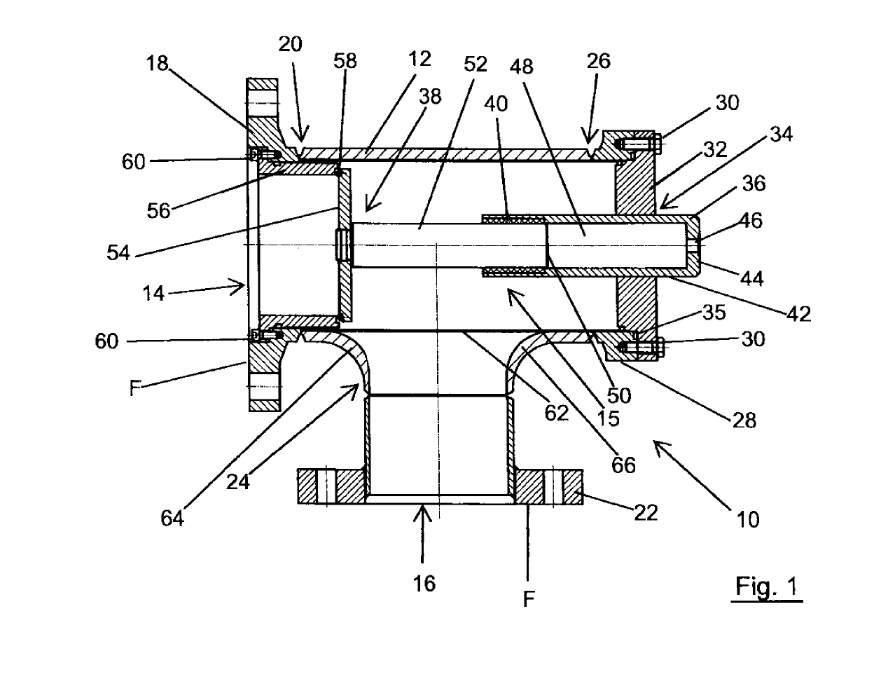

FIG. 1 shows an embodiment of a non-return valve/filter assembly according to the invention, in a sectional view.

As is illustrated in FIG. 1, the non-return valve/filter assembly according to the invention, or a respective non-return valve/filter assembly 10 which can be disposed on the intake side, has a housing 12 which is configured so as to be T-shaped. The housing 12 is integrally configured. In one potential embodiment, a standard T-fitting is used as housing 12.

The assembly or the module/unit 10, respectively, furthermore has a first inlet 14, a non-return valve 15, and an outlet 16, wherein the first inlet 14 and the outlet 16 are in each case configured as respective openings. The first inlet 14 is defined or delimited, respectively, by an entry flange 18 which is disposed at a first end 20 (first opening) of the housing 12. The outlet 16 is defined or delimited, respectively, by a compressor flange 22 which is disposed at a second end 24 (second opening) of the housing 12. The entry flange 16 is provided for a connection to an intake side of a compressor which is provided with the assembly 10, while the compressor flange 22 is provided for connecting the assembly 10 to the compressor which is provided therewith. To this end, respective and correspondingly configured flange faces F are configured on the entry flange 16 and on the compressor flange 22, which by way of interaction with respective and corresponding (not illustrated) flange faces (for example on the compressor) and (not illustrated) seal elements may enable a fluid-tight connection.

A further flange, which in the context of the terminology of the present application is referred to as a non-return valve flange 28, is disposed at a third end 26 (third opening) of the housing 12 of the assembly 10.

The three abovementioned flanges, i.e. the entry flange 18, the compressor flange 22, and the non-return valve flange 28 are connected to the housing 12 in a fluid-tight manner. In the present embodiment, the three flanges are connected to the housing 12, or fastened thereto, respectively, by way of a welding method. As an alternative thereto, a connection by way of soldering/brazing or welding, or else by shrink-fitting thereinto or thereonto, respectively, (in the case of a corresponding configuration of the housing 12 and of the respective flanges) would also be conceivable.

A cover 32 which is configured so as to be plate-shaped is attached to the non-return valve flange 28 by means of fastening elements in the form of screws 30, said cover 32 having a circular cross section and in the center a recess 34 which is likewise circular. In order for a fluid-tight connection between the non-return valve flange 38 and the cover 32 to be ensured, a seal element 35 in the form of an annular seal is disposed between the two components.

A guide 36 of the non-return valve 15 is disposed in a fluid-tight manner in the recess 34. Apart from the guide 36, the non-return valve 15 has a valve body 38 and a bearing which is disposed between the valve body 38 and the guide 36 and which in the presently described embodiment is configured as a linear roller bearing 40. The guide 36 is cylindrically configured, having a circular cross section, wherein also another arbitrary cross-sectional shape, for example an oval or else a rectangular cross-sectional shape, would be conceivable in alternative embodiments. The guide 36 has a cylinder sleeve 42 and a cylinder base 44 which is disposed at an end of the cylinder sleeve 42 that faces away from the entry flange 18 of the assembly 10.

The cylinder base 44 and thus the guide 36 have a second inlet in the form of a recess 46 by way of which an impinging medium, in particular a refrigerant, furthermore in particular hot gas, of a compressor may be supplied to and away from, respectively, the guide 36, i.e. into the cavity or the capacity 48 of the guide 36, respectively, that is delimited by the cylinder sleeve 42 and by the cylinder base 44. At that side of the guide 36 that is opposite the cylinder base 44 the cavity 48 is delimited by the valve body 38, more specifically by a base 50 of a cylindrically configured first body element 52 of the valve body 38, which is disposed so as to be at least partially movable to and fro in the guide 36.

The first body element 52 is cylindrically configured, having a cross-sectional shape which corresponds to the guide 36, in the presently described embodiment a circular cross-sectional shape. The cavity 48 (capacity 48) of the guide 36, which is thus delimited on all sides, for implementing the desired non-return valve function may be pressurized by way of the recess 46 with hot gas of a compressor (not illustrated in FIG. 1) or alternatively with another arbitrary medium. An impingement by way of force using a spring would also be conceivable; however, the impingement using a fluid has the advantage of no vibrations being created and of pressure losses being comparatively minor.

As has already been mentioned above, a linear roller bearing 40 by means of which the valve body 38 or the first body element 52 of the valve body 38, respectively, is mounted so as to be movable to and fro in the guide 36 is disposed between the valve body 38 and the guide 36. On account of guiding/mounting by means of the linear roller bearing 40, potential friction losses during movement of the valve body 38 in the region of the guide 36 are minimized as far as possible.

The valve body 38 furthermore has a second body element 54 which is configured in a plate-shaped manner. The second body element 54, which is fastened to the first body element 52, for implementing the desired sealing function may be brought into abutment with an abutment element which in the embodiment according to FIG. 1 is configured as a seating connector 56 which is disposed on the inlet side. In order for a good sealing function to be implemented, a seal element 58 (annular seal, O-ring) is disposed in the region of the abutment face. The seating connector 56 is fastened to the entry flange 18 by means of fastening elements in the form of screws 60 and extends across the entry flange 18 into the housing 12 of the valve 10.

It should be noted at this point that characteristic features of the construction include the stroke of the valve body 38, the seating diameter of the seating connector 56, and the radii 64 and 66, the optimal embodiment of which leads to maximum refrigeration performance of a compressor equipped with the assembly at minimal pressure losses. The seating connector 56 may be embodied both so as to be an integral component part of the entry flange 18 as well as a discrete replaceable component.

A filter 62 for filtering the medium which is guided via the valve 10 is provided in the housing of the assembly 10. In the embodiment according to FIG. 1 this is a filter insert; however, depending on the application a filter which is permanently fastened to the housing 12 is also conceivable in alternative embodiments. In the embodiment according to FIG. 1 the filter 62 is disposed in a region of the housing 12 that faces the compressor flange 22 (that is to say on the outlet side). Alternatively, disposing the filter 62 on the inlet side is also conceivable.

The housing 12 of the assembly 10 between the first inlet 14 and the outlet 16 is provided with a (first) radius 64, i.e. with a curved surface. In other words, a (first) radius 64 is configured in the region between the entry-flange side end of the housing 12 and the compressor-flange side end of the housing 12. Furthermore, a (second) radius 66 is configured in the region between the non-return valve side end of the housing 12 and the compressor-flange side end of the housing 12. In the embodiment illustrated in FIG. 1, the first and the second radius 64, 66 are identical. In alternative embodiments, dissimilar radii (depending on the desired flow profiles) may be implemented. As opposed to a housing structure which is provided with corners and edges, this ensures a construction which is favorable in terms of flow dynamics.

While the invention has been described by means of an embodiment having fixed combinations of features, said invention also comprises the further conceivable and advantageous combinations such as stated in particular but not in an exhaustive manner by the dependent claims. All features which are disclosed in the application documents are claimed as being relevant to the invention in so far as they are individually or in combination with one another novel in relation to the prior art.

### LIST OF REFERENCE SIGNS

10 Non-return valve/filter assembly
12 Housing
14 First inlet
15 Non-return valve
16 Outlet
18 Entry flange
20 First end of the housing 12
22 Compressor flange
24 Second end of the housing 12
26 Third end of the housing 12
28 Non-return valve flange
30 Screw
32 Cover
34 Recess (Clearance)
35 Seal element
36 Guide of the non-return valve 15
38 Valve body
40 Linear roller bearing
42 Cylinder sleeve
44 Cylinder base
46 Recess (Clearance)
48 Cavity or capacity, respectively
50 Base
52 First body element
54 Second body element
56 Seating connector
58 Seal element
60 Screw
62 Filter
64 First radius
66 Second radius
F Flange face

1. A non-return valve/filter assembly for a compressor, in particular for a compressor for compressing a refrigerant, wherein the assembly comprises a housing, a first inlet, and an outlet, as well as a non-return valve, wherein the housing of the assembly is configured in an integral T-shaped manner, and the assembly has a second inlet by way of which a pressurized impinging medium is suppliable.

2. The assembly as claimed in claim 1, wherein the assembly comprises a filter element.

3. The assembly as claimed in claim 1, wherein the non-return valve comprises a guide and a valve body which is disposed so as to be movable therein.

4. The assembly as claimed in claim 3, wherein a bearing is disposed between the guide and the valve body.

5. The assembly as claimed in claim 3, the second inlet for an impinging medium is disposed in the guide.

6. The assembly as claimed in claim 3, wherein the housing at the outlet side is configured so as to have a radius.

7. The assembly as claimed in claim 3, wherein the valve body comprises a cylindrically configured first body element which is disposed in the guide so as to at least partially be movable to and fro therein, as well as a second body element which is configured so as to be plate-shaped, wherein the second body element is capable of being brought into abutment with an abutment element.

8. The assembly as claimed in claim 3, wherein the guide is disposed on or in a fastening element, wherein the fastening element is indirectly or directly fastened to the housing.

9. A compressor having a compressor inlet for a medium to be compressed, wherein the compressor has an assembly according to claim 1.

10. The compressor as claimed in claim 9, wherein a fluid connection is configured between the compressor and the second inlet for an impinging medium.

11. The assembly as claimed in claim 2, wherein the filter element is a filter insert.

12. The assembly as claimed in claim 4, wherein the bearing is a linear bearing.

13. The assembly as claimed in claim 4, wherein the bearing is a linear roller bearing.

14. The assembly as claimed in claim 5, wherein the impinging medium is a refrigerant.

15. The assembly as claimed in claim 5, wherein the impinging medium is a hot gas.

16. The assembly as claimed in claim 7, wherein the abutment element is a seating connector which is disposed on the inlet side.

17. The assembly as claimed in claim 8, wherein the fastening element is a cover.

18. The compressor as claimed in claim 9, wherein the compressor is a compressor for compressing a refrigerant.
